(19) United States
(12) Patent Application Publication
(10) Pub. No.: US 2019/0098823 A1
(43) Pub. Date: Apr. 4, 2019

(54) APPLIANCE FOR MITIGATING SOIL ABRASION WEAR OF TOOL ATTACHMENT FRAME SHANKS

(71) Applicant: Ronald Gertson, East Bernard, TX (US)

(72) Inventor: Ronald Gertson, East Bernard, TX (US)

(21) Appl. No.: 16/061,290

(22) PCT Filed: Dec. 9, 2016
(86) PCT No.: PCT/US2016/065847

§ 371 Date: Jun. 11, 2018

Related U.S. Application Data
(60) Provisional application No. 62/266,117, filed on Dec. 11, 2015.

(51) Int. Cl. A01B 23/02

(52) U.S. Cl. CPC A01B 23/02

(57) ABSTRACT

An appliance can be used to mitigate or even eliminate wear from soil abrasion on the tine or shank of a cultivator. The appliances is made of a polymer and is positioned between the tine or shank and a sweep. The appliance is conveniently replaced whenever a worn sweep is replaced. By protecting the tine or shank from wear, the comparatively much more expensive tine or shank can be replaced at much longer intervals. This can save both equipment costs and downtime.

### BACKGROUND

### 1. Field of the Disclosure

The invention relates to farming implement. The invention particularly relates to appliances for mitigating soil abrasion wear of farming implements.

### 2. Background of the Disclosure

The farmers of George Washington's day had no better tools than had the farmers of Julius Caesar's day; in fact, early Roman plows were superior to those in general use in America eighteen centuries later. Mary Bell, History of the Plow, http://inventors.about.com/od/pstartinventions/a/plow.htm. Patents for plows started appearing in the early 1800's and continued to be refined during the rest of the 19^{th} century. Unfortunately plows merely open up the soil and form furrows. Many crops require that soil be conditioned using a cultivator.

After soil has been plowed, tools used to prepare a seed bed are generally referred to as cultivators. Cultivation is the act of breaking up the soil, that is breaking down large lumps of soil into smaller particles. Early in the history of cultivation a harrow was used for this purpose. It was early in the 18^{th} century that crude cultivators began to be employed. The now familiar S-tine (sometimes also referred to as a S-shank or Danish tine) cultivators, C-shank cultivators, and parabolic shank cultivators (sometimes also referred to as ripper shank) cultivators are all widely employed; generally for different purposes in modem farming.

When employed in modern farming agricultural equipment typically includes a tool frame mounted on a wheel assembly and a trailer hitch for attachment to a tractor or the like. Conventional mounting assemblies used in agricultural equipment provide for rigidly attaching the tool frames to wheel assemblies for mobility. Individual cultivator tools are attached to the tool frame. In many instances, it is desirable to put a point (sometimes referred to as a “sweep”) on at least some of the cultivator tools.

It is to be expected that during the course of use the cultivator sweeps will wear out due to abrasion from the soil being cultivated. It would be desirable in the art to mitigate or eliminate where on the cultivator tines to which the sweeps are attached.

### SUMMARY

In one aspect, the invention is an appliance useful for eliminating or mitigating wear of a cultivator shank having attached thereto a cultivator sweep, comprising a polymer body configured to attach to the cultivator shank using an attachment device of the cultivator sweep, further configured to shield the wear area on the cultivator shank from wear due to abrasion by soil.

In another aspect, the invention is a system for cultivating soil comprising an appliance useful for eliminating or mitigating wear of a cultivator shank having attached thereto a cultivator sweep, comprising a polymer body configured to attach to the cultivator shank using an attachment device of the cultivator sweep, further configured to shield the wear area on the cultivator shank from wear due to abrasion by soil.

A method for performing maintenance on a cultivator system wherein the cultivator system comprises an appliance useful for eliminating or mitigating wear of a cultivator shank having attached thereto a cultivator sweep, comprising a polymer body configured to attach to the cultivator shank using an attachment device of the cultivator sweep, further configured to shield the wear area on the cultivator shank from wear due to abrasion by soil, an S-tine shank, and a sweep, the method comprising replacing the appliance when replacing a worn sweep.

### BRIEF DESCRIPTION OF THE DRAWINGS

The other objects, features and advantages will occur to those skilled in the art from the following description of the preferred embodiment and the accompanying drawings in which:

FIG. 1 is an illustration of cultivator sweep;

FIG. 2 is an illustration of an S-tine shank;

FIG. 3 is an illustration of an S-tine shank and sweep attached to a cultivator tool frame;

FIG. 4 is an illustration of an S-tine shank and sweep with an appliance of the application in place;

FIG. 5 is an illustration of a 1^{st} face of an appliance of the application; and

FIG. 6 is illustration of a 2^{nd} face of the appliance of the application.

### DESCRIPTION

In one embodiment, the invention is an appliance useful for eliminating or mitigating wear of a cultivator shank having attached thereto a cultivator sweep, comprising a polymer body configured to attach to the cultivator shank using an attachment device of the cultivator sweep, further configured to shield the wear area on the cultivator shank from wear due to abrasion by soil.

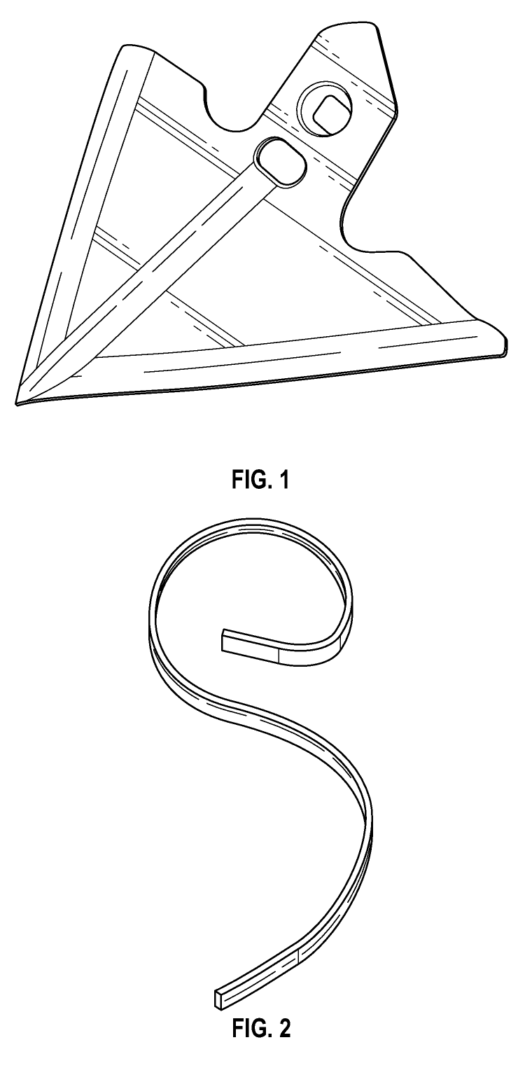

For the purposes of this application, the term “sweep” means the article of manufacture illustrated in FIG. 1. This article is applied to the end of a cultivator tine and functions to penetrate and then break up soil, sweeping the broken ups wall to the side as it is moved through the soil.

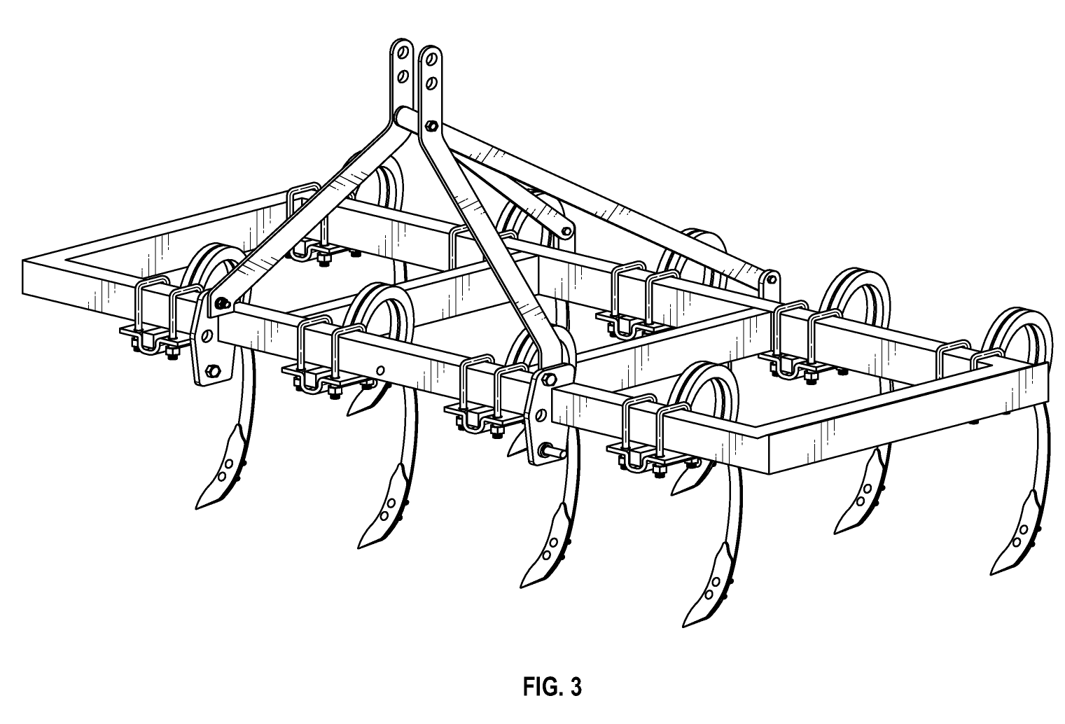

For the purposes of this application the term “S-tine” means the article of manufacture illustrated in FIG. 2. This article is referenced in the paragraph immediately above. It is shaped like a stylized “S.” in FIG. 2, the sweep attaches at the bottom of this figure while the S time attaches to a cultivator tool frame at the top of this figure. For purposes of clarity, FIG. 3 shows a cultivator tool frame having attached thereto several S-tines cultivators wherein each of the cultivators has attached thereto a sweep.

In one embodiment, an appliance of the application is prepared from a polymer. While any polymer known to be useful to those of ordinary skill in the art of making polymer articles of manufacture may be used prepare the appliance, it is desirable that the polymer used be one that will resist where from abrasive contact with soil. It would also be desirable that the polymer be one that is not excessively expensive. In one embodiment, the polymer is polyethylene, polypropylene, high density polyethylene, high density poly propylene, and combinations thereof.

In another embodiment of the invention, the polymer used to prepare the appliance is an ultra high density polyethylene. In another embodiment, the polymer used to prepare the appliance is an ultra high molecular weight polyethylene. Examples of commercially available ultra-high molecular weight polyethylene include “HI-ZEX MILLION” manufactured by Mitsui Petrochemical Industries, Ltd. and “Hostalen GUR” manufactured by Hoechst AG.

The appliances of the application are configured to attach to the cultivator shank using an attachment device of the cultivator sweep. Generally speaking, the sweep is attached to the shank or tine of a cultivator by means of a bolt or bolts. However for the purposes of this application the attachment device can be any known to be useful to those of ordinary skill in the art. Such device attachments include but are not limited to screws, cotter pins, clamps, and the like.

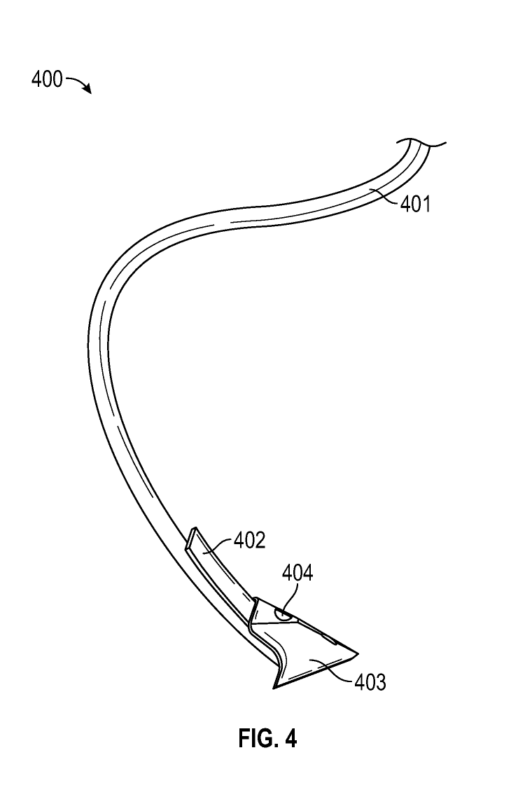

Turning to FIG. 4, an S-tine shank and sweep with an appliance of the application in place is illustrated (400). The S-tine (401) has a sweep (403) attached. In between the sweep and the S-tine is an appliance of the application (402). Finally, the top of an attachment device (404) can be seen on the face of the sweep.

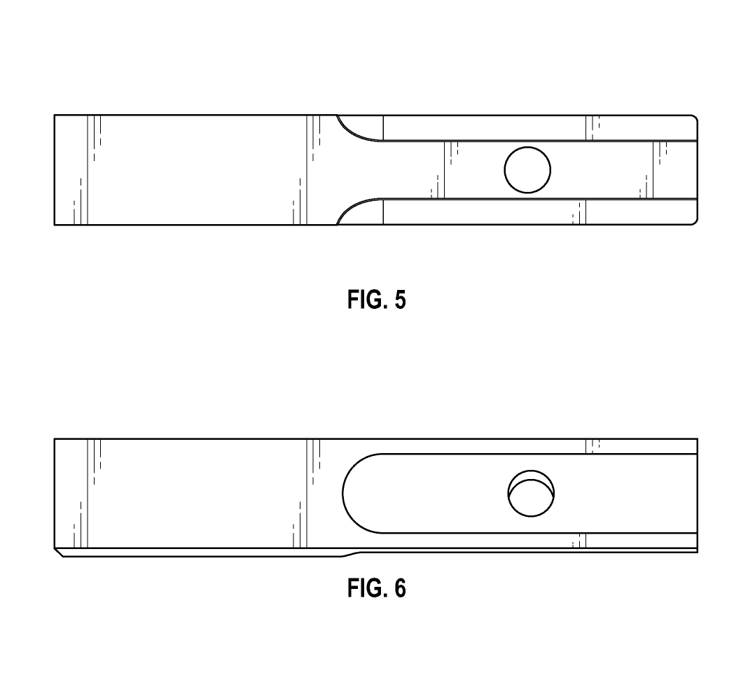

Turning to FIG. 5, a 1^{st} face of the appliance is illustrated. This face of the appliance would be turned towards the direction of the soil and away from the tine or shank of the cultivator. The flat portion of the appliance would be that part which extends above the sweep.

Turning to FIG. 6, a 2^{nd} face the appliance is illustrated. This face of the appliance would be turned towards the direction of the tine or shank. This particular appliance is configured to fit against a rounded cultivator. The cavity could as easily be rectangular to fit against a rectangular cultivator. Note that in both FIGS. 5 and 6 there's a hole present to allow the attachment device of the sweep to pass through as it connects the sweep to the shank or tine. In some embodiments, where the attachment device is not sufficiently long to allow for the extra space taken by the appliance, a longer attachment device can be employed.

The appliance body generally speaking has 2 zones. A 1^{st} zone which goes between the sweep and the tine or shank; and a 2^{nd} zone which extends up above the sweep along the upper face of the tine or shank.

While an appliance of the application may be employed with any type of cultivator, in some embodiments it may be desirable to employ it with an S-tine shank. S-tine shanks are generally prepared using spring steel. This is in marked contrast to other cultivators. For example C-shank cultivators are generally made out of cast iron or steel.

The use of spring steel for the S-tine shanks allows more energy to be input in the soil, especially in lateral motions allowing for more effective pulverization of soils, especially soft soils. It is the motion of the spring steel which tends to require more wear resistant polymers when preparing the appliances of the application. The vibrations from the spring stilled in effect create where the S-tines come into contact with the appliance.

For the purposes of this application the term “wear area” when used in association with an appliance the application means the part of the appliance that is in contact with the S-tine. This is because the S-tine can cause wear due to the vibrational movements of the spring steel.

Also for the purposes of this application the term “wear area” when used in association with a cultivator shank or tine means that part of the shank or tine which is in contact with the soil when it is moved through a soil.

The appliances of the application function by shielding the tine or shank of the cultivator from soil as the tine or shank and sweep or moved through soil. By reducing the abrasive wear on the shank or tine, maintenance can be reduced because the user does not have to replace the comparatively expensive shank or tine. In the alternative, the user merely has to replace the appliances as they wear out. Since sweeps wear out much more quickly than tines or shanks, then in one embodiment of the invention the appliance of the application would be replaced at the same time as a worn out sweep.

1-3. (canceled)

4. An appliance useful for eliminating or mitigating wear of a cultivator shank or tine having attached thereto a cultivator sweep, comprising a polymer body configured to attach to the cultivator shank using an attachment device of the cultivator sweep, further configured to shield the wear area on the cultivator shank from wear due to abrasion by soil.

5. The Appliance of claim 4 wherein the appliance is prepared from a polymer selected from the group consisting of polyethylene, polypropylene, high density polyethylene, high density poly propylene, and combinations thereof.

6. The Appliance of claim 4 wherein the appliance is prepared from ultra high density polyethylene.

7. A system for cultivating soil comprising an appliance of claim 4, an S-tine shank, and a sweep.

8. The system of claim 7 wherein the appliance is prepared from a polymer selected from the group consisting of polyethylene, polypropylene, high density polyethylene, high density poly propylene, and combinations thereof.

9. The system of claim 7 wherein the appliance is prepared from ultra high density polyethylene.

10. A method for performing maintenance on a cultivator system wherein the cultivator system comprises an appliance of claim 4, an S-tine shank, and a sweep, the method comprising replacing the appliance when replacing a worn sweep.
